(19) United States
(12) Patent Application Publication
(10) Pub. No.: US 2018/0136360 A1
(43) Pub. Date: May 17, 2018

(54) METHOD FOR DETERMINING ELEMENTAL CONCENTRATIONS IN SPECTRAL GAMMA RAY LOGGING

(71) Applicant: SONDEX WIRELINE LIMITED, Farnborough, Hampshire (GB)

(72) Inventors: Negah ARDJMANDPOUR, Farnborough, Hampshire (GB); Julian Morgan SINGER, Farnborough, Hampshire (GB)

(21) Appl. No.: 15/570,164

(22) PCT Filed: Apr. 27, 2015
(86) PCT No.: PCT/EP2015/059024

§ 371 Date: Oct. 27, 2017

(51) Int. Cl. G01V 5/06

(52) U.S. Cl. CPC G01V 5/06

(57) ABSTRACT

A method for determining the concentrations of elements within a geologic formation includes the use of an inversion algorithm that seeks to minimize a cost function. The method includes the use of an iterative process 200 that updates the calculated concentrations of each element at each iteration using the gradient of the cost function. If the method returns a negative value for any of the elemental concentrations, the corresponding derivative is set to zero and the iterative process continues. The iteration is terminated if the difference between the model and measurement becomes suitably small or if a predetermined threshold number of iterations have been taken. The results of the determination of the elemental concentrations are displayed on a computer.

### FIELD OF THE TECHNOLOGY

This invention relates generally to the exploration and production of fossil fuels from subterranean reservoirs, and more particularly to improved methods for detecting the presence of elemental concentrations using gamma ray logging.

### BACKGROUND

Over the past years, those involved in the exploration and production of fossil fuels have developed complex methods and tools for evaluating the presence of underground resources. The concentrations of radioactive isotopes of elements such as potassium, uranium and thorium in subsurface earth formations provide valuable geophysical and petrophysical information. The determination of the concentrations of these isotopes is made with radioactive well logging techniques.

In many cases, a logging tool is used to measure the amount of naturally occurring radiation from the formation. Shales often emit more gamma rays than other sedimentary rocks because shales include radioactive potassium, uranium and thorium. Using a multichannel detector, the naturally occurring radiation can be evaluated at a number of different energies and then compared against known spectra corresponding to constituent components that are expected in the formation.

A conventional approach for determining the concentrations from gamma ray spectra is based on minimizing the square of residuals using the weighted least square method expressed by the following equation:

F=½Σᵢ₌₁^{N}W(Ax−p)² (1)

where “p” is a vector representing the measured spectrum, “A” is a matrix of the standards for each element, “W” is a weight matrix, N is number of channels in the spectra, with each channel corresponding to a range of energy, and x is a matrix that represents the elemental concentrations. To minimize equation 1, the derivative of F is taken with respect to x. Setting the result equal to zero, x can be estimated as follows:

x=(A^{T}WA)⁻¹A^{T}Wp (2)

This equation can be referred to as a direct solver and represents the conventional method for determining the measured elemental concentrations. Importantly, however, the minimization of the cost function (F) without any conditions can give negative concentrations with sensitive spectra. The presence of these non-physical results affects the rest of the analysis. The negative results of any of the elemental concentrations can lead to the wrong value for other elements, so that the conventional approach of limiting the negative concentrations to zero does not solve the problem.

Accordingly, there remains a need for an improved method for determining elemental concentrations using spectral natural gamma ray logging. It is to this and other deficiencies in the prior art that the present invention is directed.

### SUMMARY OF THE INVENTION

In an embodiment, the present invention includes an improved method for determining elemental concentrations based on measurements from spectral natural gamma ray logging. In an embodiment, the method includes the step of measuring radiation levels in the underground formation with a detector that includes (N) channels. The measured spectral radiation from the underground formation is stored in a measured matrix (p) that includes the measured radiation level at each channel (N). The method continues with the step of providing a standards matrix (A) that includes the established radiation levels for each of the plurality of elements at each energy level corresponding to each channel (N). The process continues with the step of calculating a proportion matrix (x) that provides the concentrations of each of the plurality of elements in the underground formation. The step of calculating the proportion matrix (x) includes using a direct solver equation to determine initial values for the proportion matrix (x), applying the initial values of the proportion matrix (x) to the standards matrix (A) to create an initial proportion model (Ax). Next, the difference between the initial proportion model (Ax) and the measured matrix (p) is determined. A weight matrix (W) is provided and then applied to the difference between the proportion model (Ax) and the measured matrix (p) to normalize the established radiation levels for each of the plurality of elements. The weighted difference between the proportion model (Ax) and the measured matrix (p) across all (N) channels provides the basis for a cost function (F). The cost function (F) is then minimized over a series of iterations to determine a best solution for the proportion matrix (x). During each iteration, the derivatives of the cost function (F) are calculated with respect to (x) to obtain the gradient (dF/dx). A gradient factor is then determined by multiplying the gradient (dF/dx) by a step size factor (α). The values of the proportion matrix (x) are updated by subtracting the gradient factor and iteratively repeating the determination of the proportion matrix (x). The process further includes the step of displaying the calculated values for the proportion matrix (x) on a computer.

### BRIEF DESCRIPTION OF THE DRAWINGS

FIG. 1 depicts a downhole logging system constructed.

FIG. 2 is a graph depicting standard spectra for thorium.

FIG. 3 is a graph depicting sample standard spectra for uranium.

FIG. 4 is a graph depicting sample standard spectra for potassium.

FIG. 5 is a flowchart depicting a method for determining elemental concentrations from measured spectra in spectral natural gamma ray logging.

FIG. 6 is a graph depicting a measured spectra and a comparison of a fit using a direct solver method and a fit using the iterative method of embodiments disclosed herein.

### DETAILED DESCRIPTION OF THE INVENTION

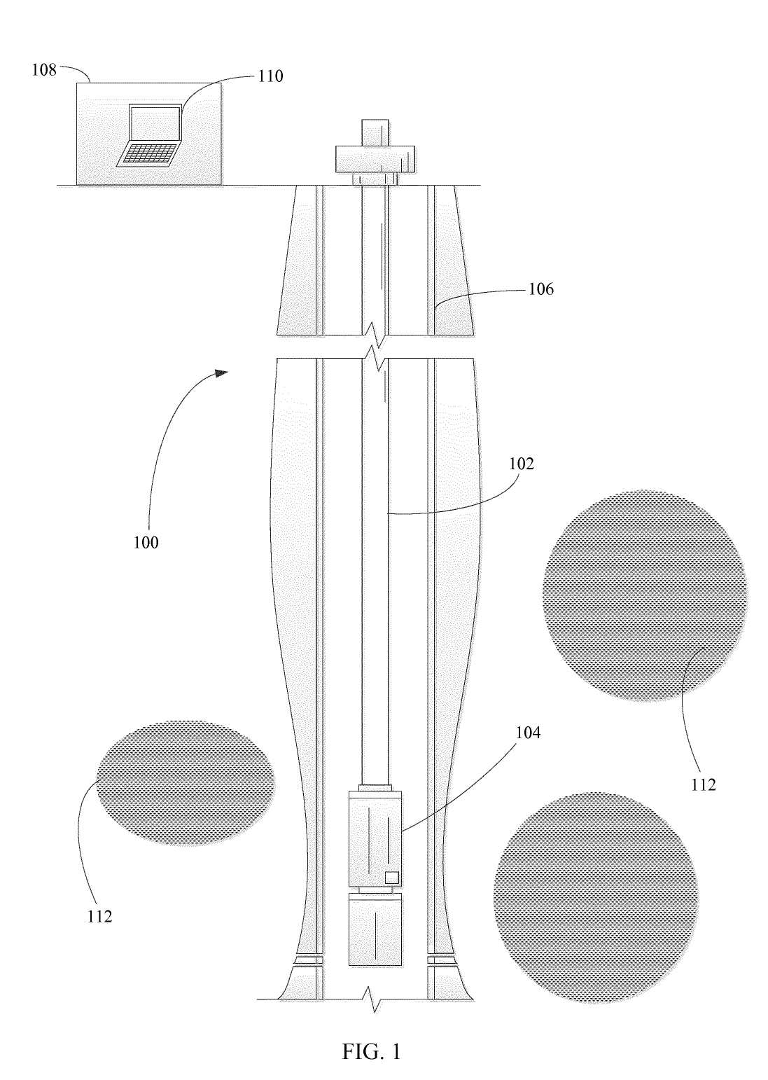

Embodiments of the present invention include an improved method for determining elemental concentrations using spectral natural gamma ray logging. Referring to FIG. 1, shown therein is a logging system 100 configured to carry out the analytic methods of embodiments. The logging system 100 in an embodiment includes a wireline 102 and a multichannel sensor 104 that are disposed in a wellbore 106. The wireline 102 and sensor 104 are connected to surface facilities 108 and a computer 110. Although the computer 110 is depicted at the surface and in close proximity to the wellbore 106, it will be appreciated that the computer 110 may be positioned at a remote location and connected to the sensor 104 via a networked connection. Alternatively, the computer 110 may by embodied by a processor or computer located within the downhole portion of the logging system 100. In yet another embodiment, the sensor 104 is contained within a downhole pumping system or drilling system.

In an embodiment, the sensor 104 is configured and positioned to detect the emission of naturally occurring gamma ray radiation from the constituent components within the formation 112. The sensor 104 is configured to output signals to the computer 110 representative of the measured radiation. The logging system 100 may optionally include an emitter that irradiates the formation 112 to produce the release of characteristic radiation from the formation.

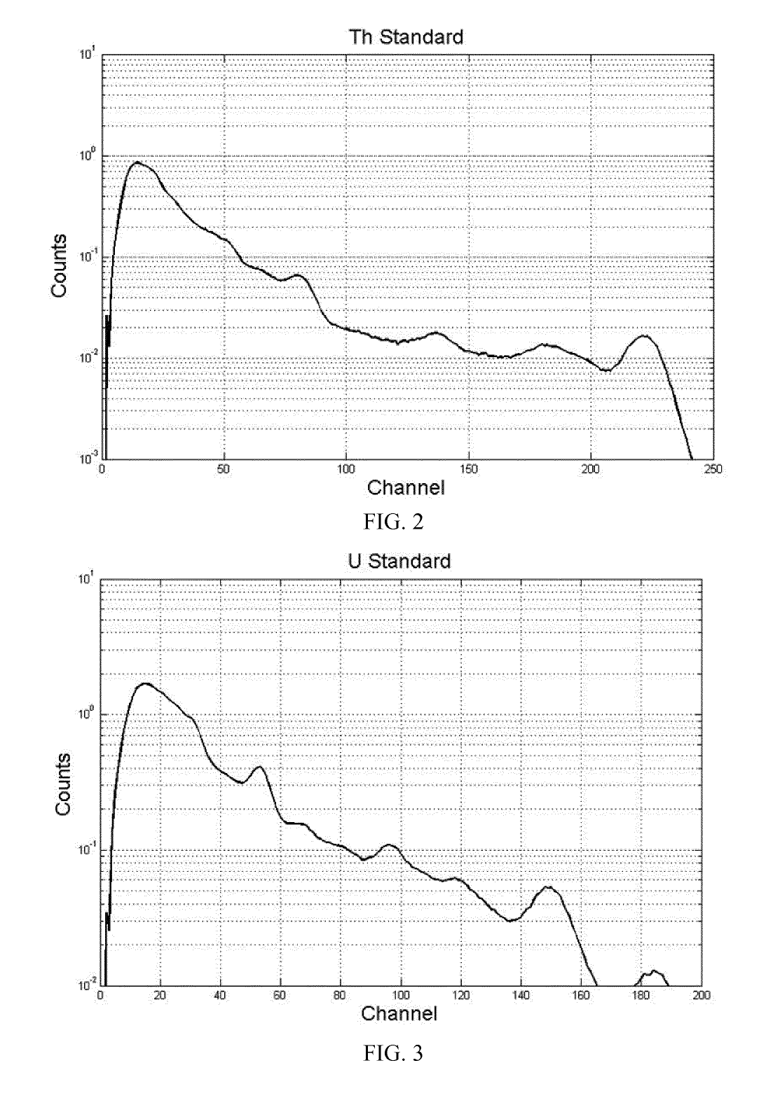

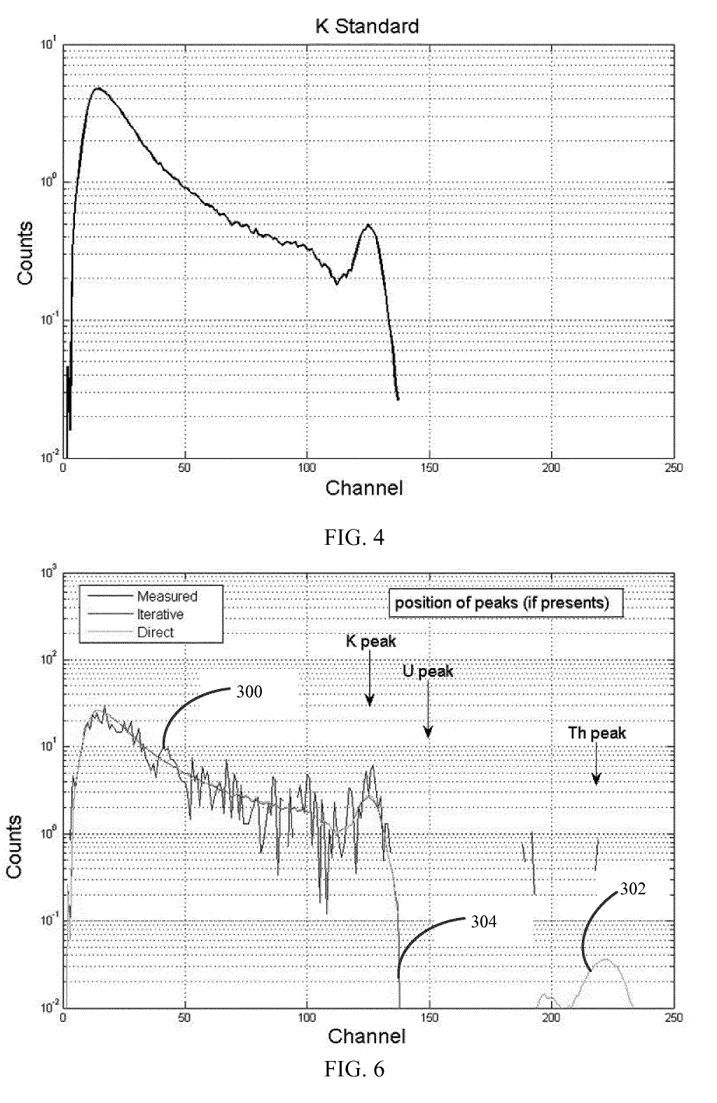

In an embodiment, the sensor 104 includes about 256 channels that are each configured to measure quantity (counts) of radiation at different energies on the spectrum. FIGS. 2-4 depict the radiation spectra of thorium (Th), potassium (K) and uranium (U) for the sensor 104 and for one unit of concentration. The 256 channels of the sensor 104 are in an embodiment selected to measure energies within the signature radiation spectra of these radioactive elements.

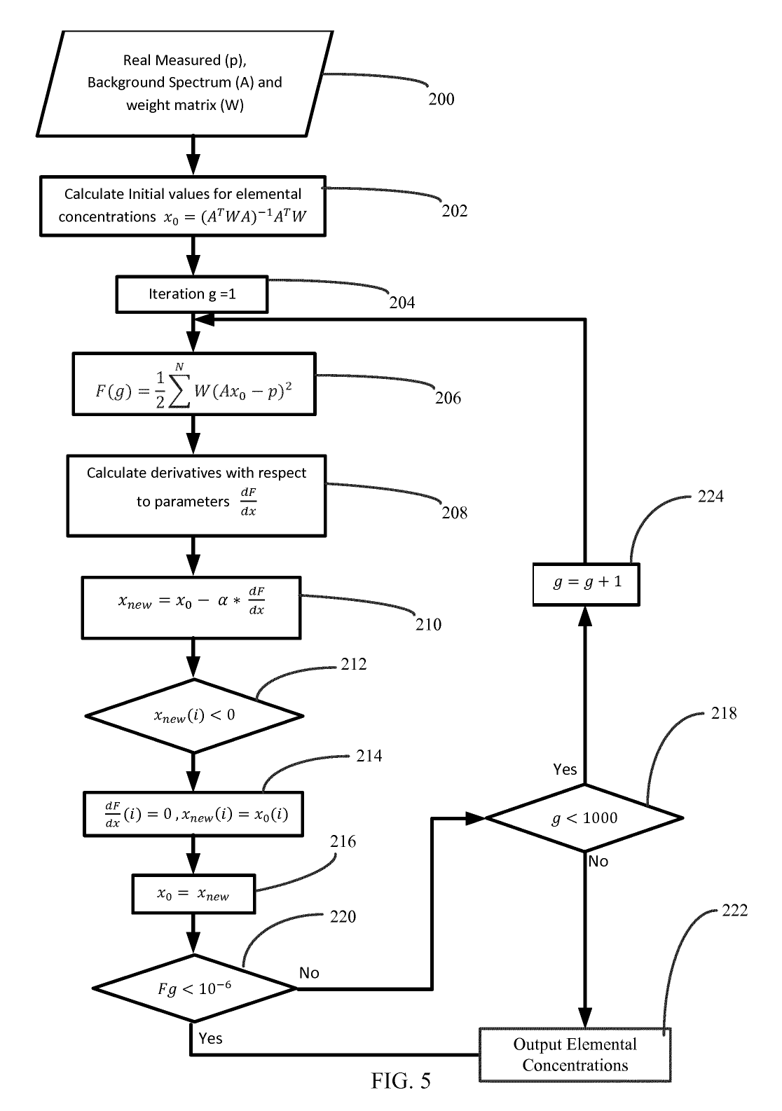

The determination of the proportions of potassium, uranium and thorium in the formation is made using an iterative method 200 shown in FIG. 5. As explained below, the iterative method 200 solves for the elemental concentrations of potassium, uranium and thorium using a gradient method with non-negative constraints. Notably, the proposed method is superior to prior art approaches because it prevents a mathematical result that returns a negative value for the concentration of one or more of the elements.

Generally, the method 200 provides an inversion algorithm that seeks to minimize the cost function F (equation 1). Giving an initial guess to the elemental concentrations, the gradient of the cost function is used to update the solution at each iteration. If any of the elemental concentrations are negative, the corresponding derivative is set to zero and the process continues. The iteration is terminated if the difference between the model and measurement becomes suitably small (e.g., 1e-6) or if a suitably large number (e.g., 1000) of iterations have been taken.

Thus, the method 200 begins with a measured matrix (p) that includes the output from the sensor 104 and represents the measured radiation spectrum, a standards matrix (A) that represents that previously established model or signature spectra for each of the elements under evaluation and a weight matrix (W) that is used to normalize the radiation levels within the various spectra. In an embodiment, the measured matrix (p) constitutes a single row matrix with 256 columns that correspond to each channel of the sensor 104, the standards matrix (A) includes three rows (each corresponding to a unique element) with 256 columns that correspond to the established spectra across the 256 channels, and weight matrix (W) is a diagonal matrix that is applied to the difference between the proportion model (Ax) and the measured matrix (p) to normalize the established radiation levels for each of the plurality of elements.

At step 202, the initial values (x₀) for a proportion matrix (x) are calculated using the direct solver (equation 2). In the embodiment, proportion matrix (x) is a single row, three-column matrix with each entry corresponding to the proportion of a different one of the three elements under evaluation. The iterative process begins at step 204 with the first iteration (g) with the initial values for the proportion matrix (x) defined as (x_{old}).

At step 206, the cost function (F) (equation 1) is evaluated with the initial values (x_{old}) using a weighted least squares method for each channel (N). Notably, the difference between the initial proportion model (Ax) and the measured matrix (p) is determined. The weight matrix (W) is provided and then applied to the difference between the proportion model (Ax) and the measured matrix (p). The weighted difference between the proportion model (Ax) and the measured matrix (p) across all (N) channels provides the basis for the cost function (F).

At step 208, the derivatives of the cost function (F) are calculated with respect to (x) to obtain the gradient (dF/dx). A provisional new solution for the proportion matrix (x_{new}) is then calculated by subtracting a gradient factor from the current solution for the proportion matrix (x_{old}). The gradient factor is defined as the product of the gradient (dF/dx) and a step size factor (α). The step size factor (α) is in an embodiment small so that the incremental change between iterations is well controlled. In an embodiment, the step size factor (α) is set at 0.01. The value of the step size factor (α) can be adjusted to change the rate of convergence around a solution.

Next, the method 200 moves to a decision step 212 that queries whether the provisional solution (x_{new}) includes a negative entry. If an entry (i) within (x_{new}) is negative, the derivative of (dF/dx) for that element is set to 0, and the value for that entry is returned to the former value (i.e., (x_{new}(i)=x_{old}(i)). At step 216, (x_{old}) is then set for the subsequent iteration as equal to the determined value of (x_{new}). If, on the other hand, no entries (i) within (x_{new}) are negative, the method moves directly to step 216 without the intervening step 214 and (x_{old}) is updated for the subsequent iteration as the value of (x_{new}).

Next, the method 200 moves to two decision steps 218, 220. At decision step 218, the method queries whether the value of the cost function (F) determined at step 206 during the current iteration is sufficiently small. In an embodiment, the decision step 218 queries whether the cost function returned a result less than 1×10⁻⁶. If so, the method 200 moves to step 222 and the results of the proportion matrix (x) are displayed and the method 200 ends. If not, the method 200 progresses to step 220, which queries whether a predefined number of iterations have occurred. In an embodiment, the maximum number of iterations is set at 1,000. If less than 1,000 iterations have occurred, the method moves to step 224 and the iteration count (g) is incremented by 1 before returning to step 206. If the predefined number of iterations has occurred (e.g., g=1000), the method moves to step 222 and the results of the proportion matrix (x) are displayed and the method 200 ends. It will be appreciated that the results of the method 200 may be displayed, printed, recorded or automatically ported as inputs into additional calculations.

Thus, the method 200 provides an iterative process for solving the cost function (F) that eliminates the possibility of physically impossible negative elemental proportions that jeopardize the determination of the proportions of the remaining elements. A comparison of the method 200 is compared against the conventional “direct solver” approach in FIG. 6. For a measured spectra 300, the conventional solution 302 yielded concentrations of 5.9501% potassium, −2.4817 ppm uranium and 2.3967 ppm thorium, respectively. The negative proportion of uranium erroneously skewed and exaggerated the presence of thorium. In contrast, the curve 304 and solution generated by the iterative method 200 more accurately reflects concentrations of 5.4274% potassium, 0.0001 ppm uranium and 0.3523 ppm thorium. This illustrates the benefits realized through the use of the iterative method 200 with non-negative constraints of embodiments.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What we claim is:

1. A method for determining the proportions of a plurality of elements in an underground formation and displaying the results on a computer, the method comprising the steps of:
measuring radiation levels in the underground formation with a detector that includes channels, wherein each channel corresponds to a range of energy;
storing data representative of measured spectral radiation from the underground formation in a measured matrix, wherein the measured matrix includes the measured radiation level at each channel;
providing a standards matrix that includes the established radiation levels for each of the plurality of elements at each energy level corresponding to each channel;
calculating a proportion matrix that provides the concentrations of each of the plurality of elements in the underground formation, wherein the step of calculating the proportion matrix further comprises:
using a direct solver equation to determine initial values for the proportion matrix;
applying the initial values of the proportion matrix to the standards matrix to create an initial proportion model;
comparing the initial proportion model against the measured matrix using a cost function;
updating the values of the proportion matrix by subtracting a gradient factor; and
iteratively repeating the determination of the proportion matrix; and
displaying the calculated values for the proportion matrix on the computer.

2. The method of claim 1, wherein the step of comparing the initial proportion model against the measured matrix further comprises:
providing a weight matrix; and
multiplying the weight matrix to the difference between the proportion model and the measured matrix to normalize the established radiation levels for each of the plurality of elements within the cost function.

3. The method of claim 1, wherein the step of updating the values of the proportion matrix further comprises:
finding the gradient of the cost function;
determining a gradient factor by multiplying the gradient of the cost function by a step size factor; and
subtracting from the current values of the proportion matrix the gradient factor.

4. The method of claim 1, wherein the step of updating the values of the proportion matrix further comprises:
determining if any of the updated values within the proportion matrix is negative; and
setting the gradient equal to zero for any element that returns a negative value within the proportion matrix.

5. The method of claim 1, wherein the step of updating the values of the proportion matrix is repeated until the value of the cost function is below a predetermined threshold.

6. The method of claim 5, wherein the predetermined threshold is 1×10⁻⁶.

7. The method of claim 5, wherein the step of updating the values of the proportion matrix is repeated until the step of iteratively repeating the determination of the proportion matrix has been performed a predetermined number of times.

8. A method for determining the proportions of a plurality of elements in an underground formation and displaying the results on a computer, the method comprising the steps of:
measuring radiation levels in the underground formation with a detector that includes channels, wherein each channel corresponds to a range of energy;
storing data representative of measured spectral radiation from the underground formation in a measured matrix, wherein the measured matrix includes the measured radiation level at each channel;
providing a standards matrix that includes the established radiation levels for each of the plurality of elements at each energy level corresponding to each channel;
calculating a proportion matrix that provides the concentrations of each of the plurality of elements in the underground formation, wherein the step of calculating the proportion matrix further comprises:
determining initial values for the proportion matrix;
applying the initial values of the proportion matrix to the standards matrix to create an initial proportion model;
comparing the initial proportion model against the measured matrix using a weighted least squares equation;
calculating the gradient of the weighted least squares equation for each of the plurality of elements;
updating the values of the proportion matrix by subtracting a gradient factor, wherein the gradient factor is the product of a step size factor and the gradient of the weighted least squares equation for each of the plurality of elements;
setting to zero the gradient of the weighted least squares equation for any element for which the gradient of the weighted least squares equation is negative; and
iteratively repeating the determination of the values of the proportion matrix; and
displaying the calculated values for the proportion matrix on the computer.

9. The method of claim 8, wherein the step of comparing the initial proportion model against the measured matrix further comprises:
providing a weight matrix; and
multiplying the weight matrix to the difference between the proportion model and the measured matrix to normalize the established radiation levels for each of the plurality of elements within the cost function.

10. A method for determining the proportions of a plurality of elements in a geologic formation, the method comprising the steps of:
establishing a background curve that includes signature composite radiation spectra of each of the plurality of elements, wherein the background curve includes anticipated radiation levels for each of the plurality of elements across a common spectrum of energies;
acquiring data representative of the measured spectral radiation from the geologic formation;
establishing a measured curve that corresponds to the measured radiation levels across the common spectrum of energies;
providing an initial estimation for the concentrations of each of the plurality of elements;
applying a cost function to determine the accuracy of the initial estimation for the elemental concentrations;
taking the gradient of the cost function;
calculating a subsequent estimation for the concentration of each of the plurality of elements by subtracting from the initial estimations an amount equal to a step size factor multiplied by the gradient of the cost function;
determining if the concentrations of any of the plurality of elements within the subsequent estimation are negative and modifying the subsequent estimation for the concentration of each of the plurality of elements by setting the gradient of the cost function to zero for any element that returns any such negative concentration; and
using the subsequent estimation for the concentration of each of the plurality of elements as the starting values for another application of the cost function routine.

11. The method of claim 10, wherein the step of using the subsequent estimation for the concentration of each of the plurality of elements as the starting values for another application of the cost function is iteratively repeated a predetermined number of times.

12. The method of claim 10, wherein the step of using the subsequent estimation for the concentration of each of the plurality of elements as the starting values for another application of the cost function is iteratively repeated until the value of the cost function is less than a predetermined threshold value.

13. The method of claim 10, wherein the step size factor is less than 1.

14. The method of claim 10, wherein the step of acquiring data representative of the measured spectral radiation from the rock formation further comprises using a multichannel radiation detector.

15. The method of claim 10, wherein the step of providing an initial estimation for the concentrations of each of the plurality of elements further comprises using a direct solver equation according to the formula x=(A^{T}WA)⁻¹A^{T}Wp, where represents that elemental concentrations, is a matrix representative of the background curve, is a weight matrix and is a matrix representing the measured spectral radiation.

16. The method of claim 10, wherein the cost function is a weighted least squares function according to the formula
F=½Σᵢ₌₁^{W}W(Ax−p)².
where (x) represents that elemental concentrations, is a matrix representative of the background curve, is a weight matrix, is a matrix representing the measured radiation spectrum and represents the number of channels in the measured radiation spectrum.

17. The method of claim 10, further comprising the step of outputting the calculated values for the elemental concentrations on a computer.
